(19) United States
(12) Patent Application Publication
(10) Pub. No.: US 2025/0071674 A1
(43) Pub. Date: Feb. 27, 2025

(54) COMMUNICATION METHOD, NETWORK DEVICE AND TERMINAL DEVICE

(71) Applicant: GUANGDONG OPPO MOBILE TELECOMMUNICATIONS CORP., LTD., Dongguan (CN)

(72) Inventors: Fei LU, Dongguan (CN); Haorui YANG, Dongguan (CN); Yang XU, Dongguan (CN)

(21) Appl. No.: 18/944,656

(22) Filed: Nov. 12, 2024

Related U.S. Application Data
(63) Continuation of application No. PCT/CN2022/093669, filed on May 18, 2022.

(51) Int. Cl. H04W 48/18

(52) U.S. Cl. CPC H04W 48/18

(57) ABSTRACT

An access network device includes a processor and a memory, where the memory is configured to store a computer program, the processor is configured to invoke and execute the computer program stored in the memory, to cause the access network device to perform: receiving uplink data information sent from a terminal device; determining a first core network device based on first information in the uplink data information; and sending the uplink data information to the first core network device.

### CROSS-REFERENCE TO RELATED APPLICATION

This application is a Continuation Application of International Application No. PCT/CN2022/093669 filed on May 18, 2022, which is incorporated herein by reference in its entirety.

### TECHNICAL FIELD

The present application relates to the field of communication, and more specifically, to a communication method, a network device, a terminal device, a non-transitory computer-readable storage medium, a computer program product, and a computer program.

### BACKGROUND

With the development of the 5G system, requirements in the Third Generation Partnership Project (3rd Generation Partnership Project, 3GPP) standard for the 5G system to support a zero-power consumption device accessing the network have appeared. The zero-power consumption communication system may be used in scenarios such as a wireless industrial sensing network, a smart agriculture, a smart warehousing and logistic, and a smart home. However, in the 5G system, how to avoid using complex communication processes for the zero-power consumption device, thus to reduce the signaling overhead becomes a problem that needs to be solved.

### SUMMARY

Embodiments of the present application provide a communication method, a network device, a terminal device, a non-transitory computer-readable storage medium, a computer program product, and a computer program.

The embodiments of the present application provide a communication method, including:
receiving, by an access network device, uplink data information sent from a terminal device;
determining, by the access network device, a first core network device based on first information in the uplink data information; and
sending, by the access network device, the uplink data information to the first core network device.

The embodiments of the present application provide a communication method, including:
receiving, by a first core network device, uplink data information;
determining, by the first core network device, a target server based on first information in the uplink data information;
sending, by the first core network device, the uplink data information to the target server.

The embodiments of the present application provide a communication method, including:
sending, by a terminal device, uplink data information; wherein first information in the uplink data information is used to determine a first core network device and/or a target server.

The embodiments of the present application provide an access network device, including:
a first communication unit, configured to receive uplink data information sent from a terminal device, and send the uplink data information to a first core network device; and
a first processing unit, configured to determine the first core network device based on first information in the uplink data information.

The embodiments of the present application provide a first core network device, including:
a second communication unit, configured to receive uplink data information, and send the uplink data information to a target server; and
a second processing unit, configured to determine the target server based on first information in the uplink data information.

The embodiments of the present application provide a terminal device, including:
a third communication unit, configured to send uplink data information; wherein first information in the uplink data information is used to determine a first core network device and/or a target server.

The embodiments of the present application provide an access network device, including: a processor and a memory. The memory is used to store a computer program, and the processor is used to invoke and execute the computer program stored in the memory, to cause the access network device to perform the above-mentioned method.

The embodiments of the present application provide a first core network device, including: a processor and a memory. The memory is used to store a computer program, and the processor is used to invoke and execute the computer program stored in the memory, to cause the first core network device to perform the above-mentioned method.

The embodiments of the present application provide a terminal device, including: a processor and a memory. The memory is used to store a computer program, and the processor is used to invoke and execute the computer program stored in the memory, to cause the terminal device to perform the above-mentioned method.

The embodiments of the present application provide a chip for implementing the above-mentioned method.

In some embodiments, the chip includes: a processor, which is used to invoke and execute a computer program from a memory, to cause a device equipped with the chip to perform the above-mentioned method.

The embodiments of the present application provide a non-transitory computer-readable storage medium for storing a computer program. When the computer program is executed by a device, enabling the device to perform the above-mentioned method.

The embodiments of the present application provide a computer program product, including a computer program instruction, which causes a computer to perform the above-mentioned method.

The embodiments of the present application provide a computer program, when the computer program is executed on a computer, enabling the computer to perform the above-mentioned method.

### BRIEF DESCRIPTION OF THE DRAWINGS

FIG. 1 is a schematic diagram of an application scenario according to the embodiments of the present application.

FIG. 2 is a structural diagram of components of a zero-power consumption communication system according to the embodiments of the present application.

FIG. 3 is a first schematic flowchart of a communication method according to an embodiment of the present application.

FIG. 4 is a second schematic flowchart of a communication method according to an embodiment of the present application.

FIG. 5 is a third schematic flowchart of a communication method according to an embodiment of the present application.

FIG. 6 to FIG. 9 are flowcharts of various examples of communication methods according to the embodiments of the present application.

FIG. 10 is a schematic block diagram of an access network device according to an embodiment of the present application.

FIG. 11 is a schematic block diagram of a first core network device according to an embodiment of the present application.

FIG. 12 is a schematic block diagram of a terminal device according to an embodiment of the present application.

FIG. 13 is a schematic block diagram of a communication device according to the embodiments of the present application.

FIG. 14 is a schematic block diagram of a chip according to the embodiments of the present application.

FIG. 15 is a schematic block diagram of a communication system according to the embodiments of the present application.

### DETAILED DESCRIPTION

The technical solutions in the embodiments of the present application will be described in conjunction with the drawings in the embodiments of the present application.

The technical solutions of the embodiments of the present application may be applied to various communication systems, such as: a Global System of Mobile communication (Global System of Mobile communication, GSM) system, a Code Division Multiple Access (Code Division Multiple Access, CDMA) system, a Wideband Code Division Multiple Access (Wideband Code Division Multiple Access, WCDMA) system, a General Packet Radio Service (General Packet Radio Service, GPRS), Long Term Evolution (Long Term Evolution, LTE) system, an Advanced long term evolution (Advanced long term evolution, LTE-A) system, New Radio (New Radio, NR) system, a NR system evolution system, a LTE on unlicensed spectrum (LTE-based access to unlicensed spectrum, LTE-U) system, a NR on unlicensed spectrum (NR-based access to unlicensed spectrum, NR-U) system, a Non-Terrestrial Networks (Non-Terrestrial Networks, NTN) system, a Universal Mobile Telecommunication System (Universal Mobile Telecommunication System, UMTS), a Wireless Local Area Networks (Wireless Local Area Networks, WLAN), a Wireless Fidelity (Wireless Fidelity) system. Fidelity, WiFi), a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (Device to Device, D2D) communication, Machine to Machine (Machine to Machine, M2M) communication, Machine Type Communication (Machine Type Communication, MTC), Vehicle to Vehicle (Vehicle to Vehicle, V2V) communication, or Vehicle to everything (Vehicle to everything, V2X) communication, etc., and the embodiments of the present application may also be applied to these communication systems.

In a possible implementation, the communication system in the present application may be applied to a carrier aggregation (Carrier Aggregation, CA) scenario, may also be applied to a dual connectivity (Dual Connectivity, DC) scenario, and may also be applied to a standalone (Standalone, SA) network deployment scenario.

In a possible implementation, the communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as an unshared spectrum.

The embodiments of the present application describe various embodiments in conjunction with a network device and a terminal device, where the terminal device may also be referred to as a user device (User Equipment, UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (Wireless Local Loop, WLL) station, or a personal digital assistant (Personal Digital Assistant, PDA) device, a handheld device with a wireless communication function, a computing device or other processing devices connected to a wireless modem, a vehicle-mounted device, a wearable device, a terminal device in a next-generation communication system such as in an NR network, or a terminal device in a Public Land Mobile Network (Public Land Mobile Network, PLMN) network evolved in the future, etc.

In the embodiments of the present application, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the present application, the terminal device may be a mobile phone, a pad, a computer with a wireless transceiving function, a Virtual Reality (Virtual Reality, VR) terminal device, an Augmented Reality (Augmented Reality, AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, etc.

As an example but not a limitation, in the embodiments of the present application, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the present application, the network device may be a device used for communicating with a mobile device. The network device may be an Access Point (Access Point, AP) in the WLAN, a base station (Base Transceiver Station, BTS) in the GSM or CDMA, may also be a base station (NodeB, NB) in the WCDMA, or may also be an evolutionary base station (Evolutionary Node B, eNB or eNodeB) in the LTE, or a relay station or an access point, or a vehicle-mounted device, a wearable device, and a network device (gNB) in an NR network, or a network device in the PLMN network evolved in the future or a network device in the NTN network, etc.

As an example but not a limitation, in the embodiments of the present application, the network device may have a mobile characteristic, for example, the network device may be a mobile device. Optionally, the network device may be a satellite or a balloon station. For example, the satellite may be a low earth orbit (low earth orbit, LEO) satellite, a medium earth orbit (medium earth orbit, MEO) satellite, a geostationary earth orbit (geostationary earth orbit, GEO) satellite, a high elliptical orbit (High Elliptical Orbit, HEO) satellite, etc. Optionally, the network device may also be a base station provided on land, water, and other places.

In the embodiments of the present application, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc., these small cells have characteristics of small coverage range and low transmission power, which are applicable for providing a data transmission service with high speed.

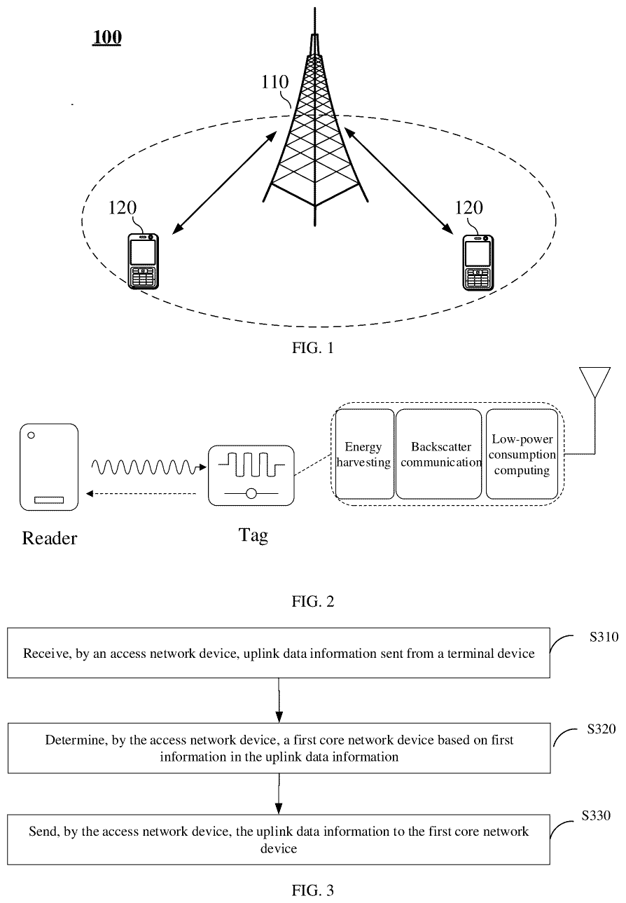

FIG. 1 exemplarily shows a communication system 100. The communication system includes a network device 110 and two terminal devices 120. In a possible implementation, the communication system 100 may include a plurality of network devices 110, and other numbers of terminal devices 120 may be included within a coverage range of the each network device 110, which is not limited to the embodiments of the present application.

In a possible implementation, the communication system 100 may further include other network entities such as a mobility management entity (Mobility Management Entity, MME) and an access and mobility management function (Access and Mobility Management Function, AMF), which is not limited to the embodiments of the present application.

Herein, network device may further include an access network device and a core network device. That is, a wireless communication system further includes a plurality of core networks for communicating with access network devices. The access network device may be an evolutional base station (evolutional node B, referred to as eNB or e-NodeB for short), a macro base station, a micro base station (also referred to as a “small base station”), a pico base station, an access point (access point, AP), a transmission point (transmission point, TP) or a new generation base station (new generation Node B, gNodeB), etc., in a long-term evolution (long-term evolution, LTE) system, a next-generation (mobile communication system) (next radio, NR) system or an authorized auxiliary access long-term evolution (LAA-LTE) system.

It should be understood that a device with a communication function in a network/system in the embodiments of the present application may be referred to as a communication device. Taking the communication system shown in FIG. 1 as an example, the communication device may include a network device and a terminal device with the communication function, and the network device and the terminal device may be the exemplary devices in the embodiments of the present application, which will not be repeated herein; the communication device may also include other devices in the communication system, such as a network controller, a mobility management entity, and other network entities, which are not limited to the embodiments of the present application.

To facilitate the understanding of the embodiments of the present application, the basic procedures and basic concepts involved in the embodiments of the present application are briefly described below. It should be understood that the basic procedures and basic concepts introduced below do not limit the embodiments of the present application.

The zero-power consumption communication technology is a kind of wireless communication technology suitable for short distance and low speed rate. As shown in FIG. 2, a zero-power consumption communication system may be composed of a reader and a tag; where the tag is a zero-power consumption device. The zero-power consumption device (i.e., the tag shown in FIG. 2) mainly combines technologies such as radio frequency energy harvesting, backscatter communication, and low-power consumption computing to achieve an advantage of not carrying a power supply for a device node. The core of the radio frequency energy harvesting is converting the radio frequency energy into a direct current. The energy may be stored in a battery or a capacitor, or the energy may be directly used to drive a logic circuit, a digital chip, or a sensor assembly after being harvested, to complete modulation and transmission for backscatter signals, the harvesting and processing for sensor information and other functions and applications.

With the development of the 5G system, requirements in the 3rd Generation Partnership Project (3GPP) standard for the 5G system to support a zero-power consumption device accessing the network have appeared. The main scenarios aimed by the zero-power consumption device have the following characteristics: the environment is extreme, which is not suitable for ordinary terminals to work; terminals with very low power consumption and cost; battery-free terminals. The zero-power consumption communication system may be used in scenarios such as a wireless industrial sensing network, a smart agriculture, a smart warehousing and logistic, and a smart home. Based on energy sources and usages of the zero-power consumption device, the zero-power consumption device may be divided into the following types.
1) Passive zero-power consumption device. Such passive zero-power consumption device does not need an internal battery, and when the passive zero-power consumption device closing to a network device (such as a reader/writer of a RFID system), the passive zero-power consumption device is within a near field range formed by an antenna radiation of the network device. Therefore, an antenna of the passive zero-power consumption device generates an induced current by the electromagnetic induction, and the induced current drives a low-power consumption chip circuit of the zero-power consumption device, thus implementing tasks such as a demodulation for a forward link signal and a modulation for a backward link signal, etc. For a backscatter link, the passive zero-power consumption device uses the backscatter implementation to perform the transmission for a signal. It can be seen that the passive zero-power consumption device does not need an internal battery to drive either the forward link or the backward link, which is a truly zero-power consumption device. A radio frequency circuit and a baseband circuit of the passive zero-power consumption devices are very simple, for example, there is no need for a Low Noise Amplifier (LNA), a PA (power amplifier), a crystal oscillator, an ADC (analog-to-digital converter) and other devices. Therefore, the passive zero-power consumption device has many advantages, such as small size, light weight, very cheap price, and long service life, etc.
2) Semi-passive zero-power consumption device. The semi-passive zero-power consumption device is not equipped with a conventional battery itself, but may use a radio frequency energy harvesting module to harvest radio wave energy, and store the harvested energy in an energy storage unit (such as a capacitor) at the same time. The energy storage unit, after obtaining the energy, may drive a low-power consumption chip circuit of the zero-power consumption device, thus implementing tasks such as a demodulation of a forward link signal and a modulation of a backward link signal, etc. For a backscatter link, the zero-power consumption device uses the backscatter implementation to transmit a signal. It can be seen that the semi-passive zero-power consumption device does not need an internal battery to drive either the forward link or the backward link. Although the energy stored in the capacitor is used in work, the energy comes from the radio energy harvested by the energy harvesting module, therefore, the semi-passive zero-power consumption device is also a truly zero-power consumption device. The semi-passive zero-power consumption device inherits many advantages of the passive zero-power consumption device, so the semi-passive zero-power consumption device also has many advantages, such as small size, light weight, very cheap price, and long service life, etc.
3) Active zero-power consumption device. This kind of terminals may have an internal battery, and the battery is used to drive a low-power consumption chip circuit of the active zero-power consumption device, thus implementing tasks such as a demodulation of a forward link signal and a modulation of a backward link signal, etc. However, for a backscatter link, the active zero-power consumption device uses the backscatter implementation to perform the transmission for a signal. Therefore, this kind of active zero-power consumption device is mainly implemented in the fact that the signal transmission of the backward link does not need the terminal's own power, but uses the manner of backscattering. The internal battery of the active zero-power consumption device supplies power to the Radio Frequency Identification (RFID) chip, to increase a reading and writing distance of the tag, thus to improve the reliability of communication. Therefore, this kind of active zero-power consumption device can be applied in some scenarios with relatively high requirements on the communication distance, the reading latency, etc.

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, the character “/” herein generally means that associated objects before and after “/” are in an “or” relationship.

It should be understood that the “indication” mentioned in the embodiments of the present application may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C, or may also mean that there is an association relationship between A and B.

In the description of the embodiments of the present application, the term “corresponding” may mean that there is a direct correspondence or indirect correspondence between two objects, may also mean that there is an associated relationship between two objects, or may also mean relationships between “indicating” and “being indicated”, between “configuring” and “being configured”, etc.

To facilitate the understanding of the technical solutions of the embodiments of the present application, the relevant technologies of the embodiments of the present application are described below. The following related technologies, as optional solutions, may be randomly combined with the technical solutions of the embodiments of the present application, which all belong to the protection scope of the embodiments of the present application.

In the embodiments, a communication method is provided, which includes:
receiving, by an access network device, uplink data information sent from a terminal device;
determining, by the access network device, a first core network device based on first information in the uplink data information; and
sending, by the access network device, the uplink data information to the first core network device.

In some embodiments, the first information includes: routing-related information.

In some embodiments, the routing-related information includes at least one of: a routing-related identity or routing path information.

In some embodiments, the routing-related identity includes at least one of: an identity of routing information, or an identity of a target server.

In some embodiments, the first information includes at least one of: a device manufacturer identity, a service provider identity, or an identity of the terminal device.

In some embodiments, the uplink data information includes an uplink data container.

In some embodiments, the first information is carried by a header portion of the uplink data container, or the first information is carried by a data portion of the uplink data container.

In some embodiments, determining, by the access network device, the first core network device based on the first information in the uplink data information includes:
determining, by the access network device, the first core network device based on the routing-related information in the first information in the uplink data information.

In some embodiments, determining, by the access network device, the first core network device based on the first information in the uplink data information includes:
determining, by the access network device, the first core network device based on the first information in the uplink data information and first pre-configuration information.

In some embodiments, the first pre-configuration information includes: a parameter of a candidate device corresponding to a candidate server and supported by each candidate core network of one or more candidate core network devices; the parameter of the candidate device corresponding to the candidate server includes at least one of: an identity of a candidate device manufacturer, an identity of a candidate service provider, or an identity of a candidate device.

In some embodiments, receiving, by the access network device, the uplink data information sent from the terminal device includes:
receiving, by the access network device, the uplink data information sent from the terminal device through an access stratum (AS) connection between the access network device and the terminal device.

In some embodiments, the method further includes:
receiving, by the access network device, downlink data information sent from the first core network device; where the downlink data information is response information for the uplink data information; and
sending, by the access network device, the downlink data information to the terminal device.

In some embodiments, the downlink data information includes related information of the terminal device.

In some embodiments, the downlink data information includes a downlink data container.

In some embodiments, the terminal device is a zero-power consumption device, and/or the first core network device is a first access and mobility management function (AMF) entity.

In the embodiments, a communication method is provided, which includes:
receiving, by a first core network device, uplink data information;
determining, by the first core network device, a target server based on first information in the uplink data information; and
sending, by the first core network device, the uplink data information to the target server.

In some embodiments, the first information includes: routing-related information.

In some embodiments, the routing-related information includes at least one of: a routing-related identity or routing path information.

In some embodiments, the routing-related identity includes at least one of: an identity of routing information, or an identity of the target server.

In some embodiments, the first information includes at least one of: a device manufacturer identity, a service provider identity, or an identity of a terminal device.

In some embodiments, the uplink data information is an uplink data container.

In some embodiments, the first information is carried by a header portion of the uplink data container, or the first information is carried by a data portion of the uplink data container.

In some embodiments, determining, by the first core network device, the target server based on the first information in the uplink data information includes:
determining, by the first core network device, the target server based on the routing-related information in the first information in the uplink data information.

In some embodiments, determining, by the first core network device, the target server based on the first information in the uplink data information includes:
determining, by the first core network device, the target server based on the first information in the uplink data information and second pre-configuration information.

In some embodiments, the second pre-configuration information is shared by one or more candidate core network devices, and the one or more candidate core network devices include the first core network device; and
the second pre-configuration information includes: a parameter of a candidate device corresponding to each candidate server of one or more candidate servers; where the parameter of the candidate device includes at least one of: an identity of the candidate device, a service area of the candidate device, an identity of a candidate device manufacturer, or an identity of a candidate service provider.

In some embodiments, receiving, by the first core network device, the uplink data information includes:
receiving, by the first core network device, the uplink data information sent from an access network device.

In some embodiments, receiving, by the first core network device, the uplink data information includes:
receiving, by the first core network device, the uplink data information sent from a terminal device.

In some embodiments, receiving, by the first core network device, the uplink data information sent from the terminal device includes:
receiving, by the first core network device, the uplink data information carried by an uplink NAS transport message and sent from the terminal device; or
receiving, by the first core network device, the uplink data information carried by a control plane service request message and sent from the terminal device.

In some embodiments, the method further includes:
establishing, by the first core network device, a non-access stratum (NAS) connection with the terminal device.

In some embodiments, establishing, by the first core network device, the non-access stratum (NAS) connection with the terminal device includes:
receiving, by the first core network device, a registration request message sent from the terminal device through an access network device;
sending, by the first core network device, a registration accept message to the terminal device through the access network device; where the registration accept message is used to indicate that an establishment of the NAS connection between the terminal device and the first core network device have been completed; and
receiving, by the first core network device, a registration completion message sent from the terminal device through the NAS connection.

In some embodiments, the registration accept message carries an identity of the target server.

In some embodiments, sending, by the first core network device, the uplink data information to the target server includes:
sending, by the first core network device, the uplink data information to the target server through a second core network device.

In some embodiments, the method further includes:
receiving, by the first core network device, downlink data information sent from the target server; where the downlink data information is response information for the uplink data information; and
sending, by the first core network device, the downlink data information.

In some embodiments, the downlink data information includes related information of a terminal device.

In some embodiments, the downlink data information includes a downlink data container.

In some embodiments, receiving, by the first core network device, the downlink data information sent from the target server includes:
receiving, by the first core network device, the downlink data information sent from the target server through a second core network device.

In some embodiments, the second core network device is a network exposure function (NEF) entity.

In some embodiments, sending, by the first core network device, the downlink data information includes:
sending, by the first core network device, the downlink data information to an access network device.

In some embodiments, the sending, by the first core network device, the downlink data information includes:
sending, by the first core network device, the downlink data information to a terminal device.

In some embodiments, sending, by the first core network device, the downlink data information to the terminal device includes:
sending, by the first core network device, the downlink data information carried by a downlink NAS transport message to the terminal device.

In some embodiments, the terminal device is a zero-power consumption device.

In some embodiments, the first core network device is a first AMF entity.

In the embodiments, a communication method is provided, which includes:
sending, by a terminal device, uplink data information; where first information in the uplink data information is used to determine a first core network device and/or a target server.

In some embodiments, the first information includes: routing-related information.

In some embodiments, the routing-related information includes at least one of: a routing-related identity or routing path information.

In some embodiments, the routing-related identity includes at least one of: an identity of a target server, or an identity of routing information.

In some embodiments, the first information includes at least one of: a device manufacturer identity, a service provider identity, or an identity of the terminal device.

In some embodiments, the routing-related information is pre-configured; and/or
at least one of a device manufacturer identity, a service provider identity, or an identity of the terminal device is pre-configured.

In some embodiments, the uplink data information includes an uplink data container.

In some embodiments, the first information is carried by a header portion of the uplink data container, or the first information is carried by a data portion of the uplink data container.

In some embodiments, sending, by the terminal device, the uplink data information includes:
sending, by the terminal device, the uplink data information to an access network device through an access stratum (AS) connection between the terminal device and the access network device.

In some embodiments, the method further includes:
in a case where the terminal device is located in a target area, establishing, by the terminal device, the AS connection with the access network device; where the target area is pre-configured.

In some embodiments, sending, by the terminal device, the uplink data information includes:
sending, by the terminal device, the uplink data information to the first core network device.

In some embodiments, the uplink data information is carried by an uplink NAS transport message or carried by a control plane service request message.

In some embodiments, the method further includes:
establishing, by the terminal device, a non-access stratum (NAS) connection with the first core network device.

In some embodiments, establishing, by the terminal device, the NAS connection with the first core network device includes:
sending, by the terminal device, a registration request message to the first core network device through an access network device;
receiving, by the terminal device, a registration accept message sent from the first core network device through the access network device; where the registration accept message is used to indicate that an establishment of the NAS connection between the terminal device and the first core network device have been completed; and
returning, by the terminal device, a registration completion message to the first core network device through the NAS connection.

In some embodiments, the registration accept message carries an identity of the target server.

In some embodiments, the method further includes:
receiving, by the terminal device, downlink data information; where the downlink data information is response information for the uplink data information.

In some embodiments, receiving, by the terminal device, the downlink data information includes:
receiving, by the terminal device, the downlink data information sent from an access network device.

In some embodiments, receiving, by the terminal device, the downlink data information includes:
receiving, by the terminal device, the downlink data information sent from the first core network device.

In some embodiments, the downlink data information is carried by a downlink NAS transport message.

In some embodiments, the downlink data information includes related information of the terminal device.

In some embodiments, the downlink data information includes a downlink data container.

In some embodiments, the terminal device is a zero-power consumption device, and/or the first core network device is a first AMF entity.

FIG. 3 is a schematic flowchart of a communication method according to the embodiments of the present application. The method may optionally be applied to the system shown in FIG. 1, but is not limited thereto. The method includes at least some of the following contents.
S310: receiving, by an access network device, uplink data information sent from a terminal device;
S320: determining, by the access network device, a first core network device based on first information in the uplink data information;
S330: sending, by the access network device, the uplink data information to the first core network device.

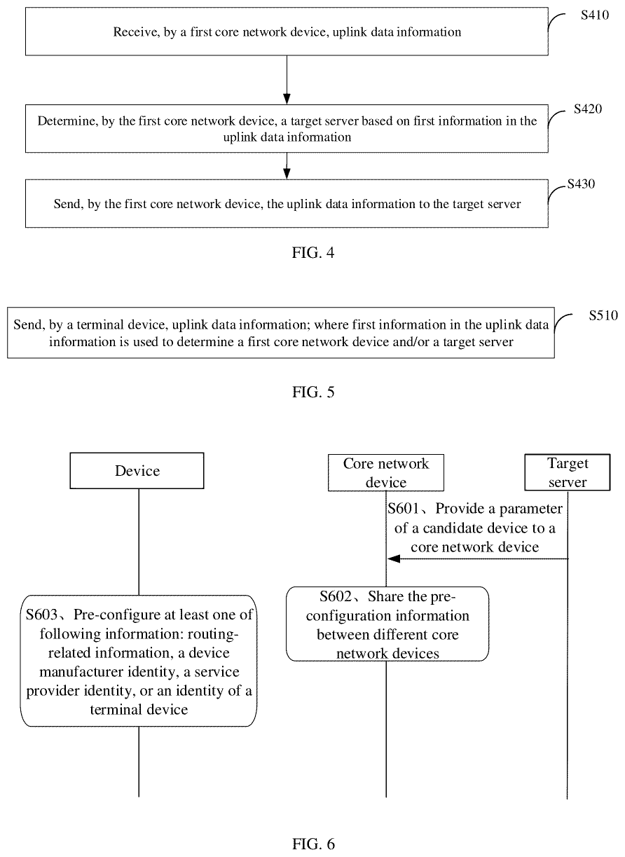

FIG. 4 is a schematic flowchart of a communication method according to the embodiments of the present application. The method may optionally be applied to the system shown in FIG. 1, but is not limited thereto. The method includes at least some of the following contents.
S410: receiving, by a first core network device, uplink data information;
S420: determining, by the first core network device, a target server based on first information in the uplink data information;
S430: sending, by the first core network device, the uplink data information to the target server.

FIG. 5 is a schematic flowchart of a communication method according to the embodiments of the present application. The method may optionally be applied to the system shown in FIG. 1, but is not limited thereto. The method includes at least some of the following contents.
S510: sending, by a terminal device, uplink data information; where first information in the uplink data information is used to determine a first core network device and/or a target server.

The above-mentioned terminal device may be a zero-power consumption device. The aforementioned access network device may be a Radio Access Network (RAN) device. The RAN device may be a base station, or a gNB, or an eNB, or the like. The first core network device may be a first AMF (Access and Mobility Management Function) entity. The target server may be an Internet of Things (IoT) server, or may be an Ambient power enabled Internet of Things (AIoT) server.

The terminal device performing the processing of S510 may be: sending, by the terminal device, the uplink data information to the access network device through an access stratum (AS) connection between the terminal device and the access network device. Alternatively, the processing of S510 may be may be: sending, by the terminal device, the uplink data information to the first core network device. The above descriptions are illustrated respectively below.

In a possible implementation, before the terminal device performs the aforementioned S510, i.e., sending, by the terminal device, the uplink data information to the access network device through the access stratum (AS) connection between the terminal device and the access network device, at least one of the following information may be pre-configured: routing-related information. The routing-related information includes at least one of: a routing-related identity or routing path information.

Herein, the routing-related identity may include at least one of: an identity of routing information, or an identity of a target server. The routing information may at least include a target address; the target address may be an address of the target server, for example, the target address may be any one of a target IP (Internet Protocol) address, or a destination layer 2 address, which is not limited herein. The identity of the target server may be pre-configured at the terminal device, or may be configured for the terminal device by a network device (such as a first core network device).

The above-mentioned routing path information may include one or more addresses of one or more devices between the terminal device (not including the terminal device) and the target server (including the target server). An address of any device may be any one of an IP address, a layer 2 address, etc., which are not exhaustively listed herein.

The pre-configured information may further include at least one of: a device manufacturer identity, a service provider identity, or an identity of the terminal device. The device manufacturer identity refers to a device manufacturer ID (Identity) of the terminal device. The service provider identity refers to an SP (Service Provider) ID that provides service support for the terminal device. The identity of the terminal device refers to an ID of the terminal device itself. The identity of the terminal device must be pre-configured at the terminal device, for example, the identity of the terminal device may be configured at the terminal device when the terminal device left the factory. The above-mentioned routing-related identity, the device manufacturer identity, the service provider identity, or a target area may be stipulated as being pre-configured at the terminal device, or may be stipulated as being configured at the terminal device according to actual conditions, or may not be configured at the terminal device.

The manner of establishing the AS connection between the terminal device and the access network device may include: in a case where the terminal device is located in a target area, establishing, by the terminal device, the AS connection with the access network device, where the target area is pre-configured.

Here, the target area may be a service area of the terminal device, and the target area may be pre-configured, that is, the service area of the terminal device is pre-configured. Herein, the target area refers to a service area of the terminal device; the service area may be represented by one or more identities of one or more target cells, or may be represented by one or more tracking area identifiers (TAIs), or may be represented by longitude and latitude coordinate information. In an example, the target area is represented by the one or more identities of the one or more target cells, i.e., the target area may be composed of the one or more target cells; where an identity of any one of the one or more target cells may be represented by a cell identity (CI). In some embodiments, the CI may be an NR Cell Global Identifier (NCGI), or an NCI (NR Cell Identifier), etc. All possible representations of the CI are not exhaustively listed herein. As another example, the target area is represented by coordinate information; where the coordinate information may include longitude and latitude information in a geographic coordinate system.

The manner for judging whether the terminal device is located in the target area may be: the terminal device acquiring a current location based on a position sensor of the terminal deice itself, and judging whether the current location is within a range of the target area based on coordinate information corresponding to the pre-configured target area; if the current location is within the range of the target area, determining that the terminal device is located in the target area; otherwise, determining that the terminal device is not located in the target area. Herein, the position sensor may be a Global Positioning System (GPS) sensor.

Alternatively, the manner for judging whether the terminal device is located in the target area may be: the terminal device acquiring a current cell identity from a system message received currently, and judging whether the current cell identity matches a target cell identity corresponding to a target area pre-configured by the terminal device itself; if the current cell identity matches the target cell identity, determining that the terminal device is located in the target area; otherwise, determining that the terminal device is not located in the target area.

The access network device refers to an access network device within the target area. That is, the above-mentioned that in a case where the terminal device is located in the target area, establishing, by the terminal device, the AS connection with the access network device may be: in a case where the terminal device is determined to be located in the target area, establishing, by the terminal device, the AS connection with the access network device within the target area. The procedures of establishing the AS connection between the terminal device and the access network device may include: after performing processing such as a public land mobile network (PLMN) selection, a cell selection, a radio resource management or other processing, the terminal device establishing the AS connection with the access network device; where the processing of the radio resource management may include a radio resource control (RRC) connection establishment procedure, etc. The procedures of establishing an AS connection between the terminal device and the access network device are not repeated herein.

Optionally, after the terminal device completes an establishment of the AS connection with the access network device, in a case where there is uplink data information that needs to be sent in the terminal device, the uplink data information may be sent to the access network device through the AS connection.

Optionally, if the access network device detects that the terminal device is in an inactive state, the access network device may further release the AS connection between the access network device and the terminal device. In this scenario, if there is uplink data information that needs to be sent in the terminal device, the terminal device and the access network device need to re-establish an AS connection, and then the terminal device sends the uplink data information to the access network device through the re-established AS connection. Herein, the access network device may determine that the terminal device is in the inactive state in a case where the access network device detects that a duration for which the terminal device has not transmitted the uplink data reaches a preset duration. The preset duration may be preset according to the actual conditions, for example, the preset duration may be 1 minute, 10 minutes, or longer or shorter, which is not limited herein. That is, the access network device determines that the terminal device is in the inactive state in a case where the access network device determines that a duration from a moment of the terminal device completing a previous transmission of the uplink data information to a current moment reaches or exceeds the preset duration.

The terminal device may generate the uplink data information based on data to be transmitted currently. Herein, the data to be transmitted currently may be service data needs to be reported by the terminal device, and the specific content is not limited in the present embodiment.

The first information includes: routing-related information, and/or the first information further includes at least one of: a device manufacturer identity, a service provider identity, or an identity of the terminal device.

Herein, the routing-related information includes at least one of: a routing-related identity or routing path information. The routing-related identity may include at least one of: an identity of routing information, or an identity of a target server.

The aforementioned uplink data information includes an uplink data container; the uplink data container may be a data container obtained by encapsulating the uplink data information to be transmitted currently. Exemplarily, the uplink data container may be an uplink (UL) Internet of Things (IoT) data container. In some embodiments, the uplink data container may be a UL Ambient power enabled Internet of Things (AIoT) data container.

The uplink data container includes a header portion and a data portion. Herein, the header portion may be represented as a header portion. Herein, the header portion of the uplink data information may be within the data portion or outside the data portion. For example, the data portion of the uplink data information, i.e., the data portion, may be a UL AIoT data container; the header portion may be within the UL AIoT data container, or may be outside the UL AIoT data container, for example, the header portion may be located in a header portion added in front of the UL AIoT data container.

The first information is carried by the header portion of the uplink data container, and/or, the first information is carried by the data portion of the uplink data container. In an example, the identity of the terminal device in the first information is carried by the data portion; the routing-related information, the device manufacturer identity, and the service provider identity in the first information are carried by the header portion.

In one case, at least one of the routing-related identity, the device manufacturer identity, or the service provider identity is pre-configured, that is, is pre-configured at the terminal device.

In this case, the uplink data information, i.e., the header portion of the uplink data container may carry at least one of the routing-related identity, the device manufacturer identity, or the service provider identity in the first information.

That is, if at least one of the routing-related identity, the device manufacturer identity, or the service provider identity is pre-configured at the terminal device side, then in a case where the terminal device generates the uplink data information, at least one of the routing-related identity, the device manufacturer identity, or the service provider identity may be carried in the first information in the uplink data information.

For example, the routing-related identity is pre-configured at the terminal device side, in a case where the terminal device generates the uplink data container, the routing-related identity in the first information is carried in the header portion of the uplink data container. As another example, the terminal device is not pre-configured with the routing-related identity, but is pre-configured with the device manufacturer identity and/or the service provider identity, in a case where the terminal device generates the uplink data container, the device manufacturer identity and/or the service provider identity in the first information is carried in the header portion of the uplink data container. As yet another example, the terminal device is pre-configured with the device manufacturer identity, the service provider identity, and the routing-related identity, in this case, the terminal device may enable that the routing-related identity in the first information is carries in the header portion of the uplink data container; or, in this case, the terminal device may enable that the device manufacturer identity, the service provider identity, and the routing-related identity in the first information is carried in the header portion of the uplink data container.

In yet another case, the terminal device is not pre-configured with any one of the routing-related identity, the device manufacturer identity, or the service provider identity. The terminal device is only pre-configured with the identity of the terminal device.

In this case, in a case where the terminal device generates the uplink data container, any one of the routing-related identity, the device manufacturer identity, or the service provider identity may not be carried in the header portion of the uplink data container.

It should be understood that if the header portion of the uplink data container does not carry any one of the routing-related identity, the device manufacturer identity, or the service provider identity, the uplink data container may still have the header portion, i.e., the header portion, but the header portion may be used to carry other predefined related information, which are not limited in the present embodiment.

The uplink data container contains the identity of the terminal device; the identity of the terminal device is pre-configured. The identity of the terminal device may be carried by the data portion of the uplink data container. The identity of the terminal device may be pre-configured in the terminal device when the terminal device left the factory to uniquely identify the terminal device. Therefore, whether the header portion of the uplink data container contains the first information may not affect whether the data portion contains the identity of the terminal device. In other words, the data portion of the uplink data container may always contain the identity of the terminal device.

Herein, the data portion of the uplink data container may carry the data to be transmitted currently besides the identity of the terminal device, but the specific contents of the data to be transmitted currently are not limited in the present embodiment.

In yet another case, the terminal device is not pre-configured with any one of the routing-related identity, the device manufacturer identity, or the service provider identity. The terminal device is only pre-configured with the identity of the terminal device. In this case, the terminal device may also be pre-configured with an identity of the target server, or the terminal device may obtain the identity of the target server in advance.

The manner of the terminal device obtaining the identity of the target server in advance may be: acquiring the identity of the target server through a registration procedure between the terminal device and the first core network. For example, the identity of the target server may be carried in a registration accept message transmitted during the registration procedure; that is, the terminal device may acquire the identity of the target server from the registration accept message.

In this case, the uplink data container contains the identity of the terminal device and the identity of the target server. In some embodiments, the header portion of the uplink data container may carry the identity of the target server, and the data portion of the uplink data container may carry the identity of the terminal device.

The terminal device sends the uplink data information to the access network device through the access stratum (AS) connection between the terminal device and the access network device. In the aforementioned S310, receiving, by the access network device, the uplink data information sent from the terminal device may include: receiving, by the access network device, the uplink data information sent from the terminal device through the AS connection between the access network device and the terminal device.

After the access network device receives the uplink data information, S320 may be performed, that is, the access network device determines a first core network device based on the first information in the uplink data information. For example, the following implementations may be included.

In one implementation, determining, by the access network device, the first core network device based on the first information in the uplink data information may include: determining, by the access network device, the first core network device based on the routing-related information in the first information in the uplink data information.

In some embodiments, the above operation may be: in a case where the first information in the uplink data information includes the routing-related information, determining, by the access network device, the first core network device based on the routing-related information.

As described above, the routing-related information may be at least one of: the routing-related identity or the routing path information. The routing-related identity includes at least one of: the identity of routing information or the identity of the target server.

Optionally, in a case where the first information in the uplink data information includes the identity of the routing information, the access network device determines the routing information based on the identity of the routing information and determines the first core network device based on the routing information. Herein, the routing information may include one or more IP addresses, and the one or more IP addresses at least include a next-hop IP address and an IP address of the target server; and the routing information may be included in a Routing Table preset by the access network device. For example, in a case where the access network device receives the uplink data information sent from the terminal device, the access network device extracts the identity of the routing information from the uplink data information, and then performs a routing query in a pre-saved routing table of the access network device itself according to the identity of the routing information, to look for routing information (or a routing entry) that matches the identity of the routing information. If the matched routing information is found, the access network device designates a core network device corresponding to an egress interface and a next-hop IP address included in the routing information as the first core network device. As another example, the routing information may also be represented in other manners, which is not limited herein. Correspondingly, in a case where the access network device receives the uplink data information sent from the terminal device, the access network device extracts the identity of the routing information from the uplink data information, and then performs a routing query in the pre-saved routing table of the access network device itself according to the identity of the routing information, to look for routing information (or a routing entry) that matches the identity of the routing information. If the matched routing information is found, the access network device designates a core network device corresponding to an egress interface and a next-hop IP address (which may be a next-hop IP address, or may be a next-hop layer 2 address, which is not limited herein) included in the routing information as the first core network device.

Optionally, in a case where the first information in the uplink data information includes the identity of the target server, the access network device determines the first core network device based on the identity of the target server. Herein, in a case where the access network device receives the uplink data information sent from the terminal device, the access network device extracts the identity of the target server from the uplink data information, determines a target address according to the identity of the target server, and performs a routing query in a pre-saved routing table of the access network device itself based on the target address to look for routing information that matches the routing-related identity. If the matched routing information is found, the access network device designates a core network device corresponding to an egress interface and a next-hop address included in the routing information as the first core network device.

Optionally, in a case where the first information in the uplink data information includes the routing path information, the access network device determines the first core network device based on the routing path information. Herein, the routing path information may include addresses of one or more devices between the terminal device (not including the terminal device) and the target server (including the target server). The one or more devices may include one or more network devices, and the one or more network devices may include at least a core network device. An address of any one of devices may be any one of an IP address, a layer 2 address, etc., which are not exhaustively listed herein. In some embodiments, when the access network device receives the uplink data information sent from the terminal device, the access network device extracts the routing path information from the uplink data information, determines a core network device corresponding to a next-hop address according to the routing path information, and designates the core network device as the first core network device.

Optionally, if there is only one candidate core network device in a current system, the access network device directly selects the candidate core network device as the first core network device. The candidate core network device is a candidate AMF; this condition is usually applicable to a standalone non-public network (SNPN).

Optionally, the processing of the access network device selecting the first core network device from one or more candidate core network devices may be: arbitrarily selecting, by the access network device, one candidate core network device from the one or more candidate core network devices as the first core network device; or, selecting, by the access network device, the one candidate core network device with the minimum load from the one or more candidate core network devices as the first core network device; or, determining, by the access network device, one or more candidate core network devices with the minimum load from the one or more candidate core network devices, and randomly selecting, by the access network device, one candidate core network device with the minimum load from the one or more candidate core network devices with the minimum load as the first core network device.

Optionally, in a case where the first information includes at least one of: the device manufacturer identity, the service provider identity, or the identity of the terminal device, determining, by the access network device, the first core network device based on the first information in the uplink data information includes: determining, by the access network device, the first core network device based on the first information in the uplink data information and first pre-configuration information. The first pre-configuration information includes: a parameter of a candidate device corresponding to a candidate server and supported by each candidate core network device of one or more candidate core network devices; the parameter of the candidate device corresponding to the candidate server includes at least one of: an identity of a candidate device manufacturer, an identity of a candidate service provider, or an identity of a candidate device.

Herein, at least one of the identity of the candidate device manufacturer, the identity of the candidate service provider, or the identity of the candidate device supported by a candidate server corresponding to each candidate core network device may be pre-configured at the each candidate core network device and may also be pre-configured at the access network device. That is, a candidate core network device may be associated with one or more candidate servers, and each candidate server reports at least one of the identity of the candidate device manufacturer, the identity of the candidate service provider, or the identity of the candidate device supported by the candidate server to the corresponding candidate core network device in advance. In addition, each candidate server may simultaneously pre-configure the at least one of the identity of the candidate device manufacturer, the identity of the candidate service provider, or the identity of the candidate device supported by the candidate server for the access network device; or each of the various candidate core network devices may synchronously save at least one of the received identity of the candidate device manufacturer, identity of the candidate service provider, or identity of the candidate device supported by the candidate core network device in the access network device. For example, there are two candidate core network devices, i.e., a candidate core network device 1 and a candidate core network device 2, in the system,; where the candidate core network device 1 is associated with two candidate servers, i.e., a candidate server 1 and a candidate server 2, respectively, an identity of the candidate device manufacturer supported by the candidate server 1 is 01, an identity of the candidate service provider supported by the candidate server 1 is 02, and an identity of the candidate device supported by the candidate server 1 is 001, and an identity of the candidate device manufacturer supported by the candidate server 2 is 03, an identity of the candidate service provider supported by the candidate server 2 is 04, and an identity of the candidate device supported by the candidate server 2 is 002. Assuming that the first information received by the access network device includes an identity of the candidate device manufacturer identity 03, the access network device may determine the candidate core network device 1 as the first core network device based on the device manufacturer identity.

The aforementioned candidate core network device may refer to a candidate AMF entity.

After the access network device completes the aforementioned processing of selecting the first core network device, the access network device may perform S330, where the access network device sends the uplink data information to the first core network device. Correspondingly, the first core network device may perform S410, and the first core network device receives the uplink data information, which may may include: receiving, by the first core network device, the uplink data information sent from the access network device.

In another possible implementation, performing, by the terminal device, the aforementioned S510, specifically may be: sending, by the terminal device, the uplink data information to the first core network device. Correspondingly, the first core network device performs S410, which may include: receiving, by the first core network device, the uplink data information sent from the terminal device.

In this implementation, before the terminal device performs S510, operations may include: establishing, by the terminal device, a NAS connection with the first core network device; correspondingly, the first core network device establishes the NAS connection with the terminal device.

The manner for establishing the NAS connection between the terminal device and the first core network may be establishing the NAS connection through a registration procedure between the terminal device and the first core network, or establishing the NAS connection by sending a control plane service request message from the terminal device to the first core network device, or establishing the NAS connection through other procedures (such as a service request procedure).

In some embodiments, establishing the NAS connection through the registration procedure between the terminal device and the first core network may include: sending, by the terminal device, a registration request message to the first core network device through the access network device; receiving, by the terminal device, a registration accept message sent from the first core network device through the access network device, where the registration accept message is used to indicate that an establishment of the NAS connection between the terminal device and the first core network device have been completed; returning, by the terminal device, a registration completion message to the first core network device through the NAS connection.

Correspondingly, establishing, by the first core network device, the NAS connection with the terminal device may include: receiving, by the first core network device, the registration request message sent from the terminal device through the access network device; sending, by the first core network device, the registration accept message to the terminal device through the access network device, where the registration accept message is used to indicate that an establishment of the NAS connection between the terminal device and the first core network device has been completed; and receiving, by the first core network device, the registration completion message sent from the terminal device through the NAS connection.

Herein, the terminal device establishes an RRC connection with the access network device, and sends the registration request message to the access network device through the RRC connection, and the access network device sends the registration request message to the first core network device; and the registration request message may be carried by a NAS message of a RRC message. The registration request message may include the identity of the terminal device. In addition, the registration request message may also include a registration type. Herein, the identity of the terminal device, similar to the above-mentioned embodiments, may be pre-configured when the terminal device left the factory.

Here, the terminal device may establish an RRC connection with an access network device that can be connected with the terminal device currently, and send the registration request message to the access network device through the RRC connection.

The first core network device may be selected by the access network device from the one or more candidate core network devices. For example, if a number of candidate core network device is one, then the candidate core network device is directly designated as the first core network device. For example, if the number of the candidate core network devices are multiple, the access network device selects any one from the multiple candidate core network devices as the first core network device. Alternatively, the access network device selects one candidate core network device with the minimum load from the multiple candidate core network devices according to the load conditions of the multiple candidate core network devices.

After the first core network device receives the registration request message, the first core network device may establish a NAS connection with the terminal device. In a case where the establishment of the NAS connection has been completed, the first core network device may send the registration accept message to the terminal device through the access network device. The registration accept message may carry a 5G Globally Unique Temporary Identifier (5G-GUTI). The 5G-GUTI may be an identity assigned to the terminal device by the first core network device, i.e., a first access and mobility management function (AMF) entity. The 5G-GUTI is a clear identity of the terminal device provided in the 5G system (5GS), which may not disclose a permanent identity of the terminal device, and is allowed to be used to identify the AMF and the network. The 5G-GUTI may be used to establish the identity of the terminal device during a signaling period between the network and the terminal device in the 5GS.

The registration accept message may further carry the identity of the target server. The target server may be a target IOT server, and for example, may be a target AIoT server. That is, the registration accept message may be used to carry a target AIoT Server ID. The identity of the target server refers to a destination identity for the terminal device to send second uplink data. As described above, the identity of the target server may be pre-configured, or may be carried in the registration accept message. That is, the identity of the target server may be carried in the registration accept message, in other words, the identity of the target server may be sent by the first core network device to the terminal device. As described above, the registration accept message may not carry the identity of the target server; correspondingly, in this case, the identity of the target server is pre-configured, for example, the identity of the target server may be preset in the terminal device when the terminal device left the factory.

After the terminal device receives the aforementioned registration accept message, the terminal device may send a registration completion message to the first core network device through the currently established NAS connection.

Through the above processing, the registration processing of the terminal device is completed, and while completing the registration processing of the terminal device, the NAS connection between the terminal device and the first core network device is established.

It should be noted that the aforementioned registration accept message may carry the identity of the target server, or may not carry the identity of the target server. In a case where the registration accept message does not carry the identity of the target server, the aforementioned procedure is only used to complete the registration of the terminal device and establish the NAS connection. In a case where the registration accept message carries the identity of the target server, the aforementioned procedure may further be used to indicate a destination address (i.e., a destination identity of the target server) for the terminal device to send uplink data. Whether the registration accept message carries the identity of the target server may be determined by the first core network device according to a pre-configured processing policy. For example, the policy may be pre-configured as that the registration accept message can carry the identity of the target server, or the policy may be pre-configured as that the registration accept message does not carry the identity of the target server, and the manners of pre-configuration are not exhaustively listed herein.

Optionally, after completing the above processing, the terminal device performs S510. In some embodiments, if the terminal device is currently in a connected state, the terminal device sends uplink data information to the first core network device through the NAS connection between the terminal device and the first core network device. The uplink data information may be carried by an uplink NAS transport (TRANSPORT) message. Correspondingly, the first core network device performs S410, and the first core network device receives the uplink data information sent from the terminal device.

In one implementation, the first core network device receives the uplink data information carried by the uplink NAS transport message sent from the terminal device.

This processing is usually applicable to a situation that after the NAS connection is established through the registration procedure aforementioned, or after the NAS connection is established by other manners, the terminal device is in the connected state, i.e., the NAS connection keeps on being established. Since the terminal device still keeps on connecting with the first core network device through the NAS connection, the terminal device may directly send the uplink data information carried by the uplink NAS transport message to the first core network device through the NAS connection between the terminal device and the first core network device.

In one implementation, the first core network device receives the uplink data information carried by a control plane service request message sent from the terminal device.

This processing is usually applicable to a situation that after the NAS connection is established through the registration procedure aforementioned, or after the NAS connection is established by other manners, the terminal device has disconnected the NAS connection, that is, the terminal device is currently in a non-connected state. Since the NAS connection between the terminal device and the first core network device has been disconnected, the terminal device enables the control plane service request message to carry the uplink data information, so that the terminal device and the first core network device can reestablish the NAS connection between the terminal device and the first core network device.

In this implementation, the first information in the uplink data information must carry the identity of the target server. Based on the above description, it could be known that the identity of the target server may be pre-configured by the terminal device, or may be carried by the registration accept message during the registration procedure. In the case where the uplink data information is an uplink data container, the identity of the target server may be carried in a header portion of the uplink data container. Of course, the identity of the target server may also be carried in a data portion of the uplink data container.

It should be pointed out that in this implementation, in addition to the identity of the target server, the first information in the uplink data information may further include at least one of the routing-related identity, the device manufacturer identity, the service provider identity, the target area, or the identity of the terminal device mentioned in the aforementioned embodiments. The carrying manner of the identity of the target server is the same as of the carrying manners of the aforementioned embodiments, which is not be repeated herein.

At the first core network device side, the uplink data information may be received from the access network device, or may be received directly from the terminal device; regardless of which of the above manners is used, in a case where the first core network device receives the uplink data information, S420 may be performed, and the first core network device determines the target server based on first information in the uplink data information.

Optionally, determining, by the first core network device, the target server based on the first information in the uplink data information may include: determining, by the first core network device, the target server based on the routing-related information in the first information in the uplink data information.

In some embodiments, in a case where the first information includes the routing-related information, the first core network device determines the routing information based on the routing-related information; and determines the target server based on the routing information.

For example, in a case where the first core network device receives the uplink data information, the first core network device extracts the identity of the routing information from the uplink data information, and then performs a routing query in a pre-saved routing table of the first core network device itself according to the identity of the routing information, to look for routing information (or a routing entry) that matches the identity of the routing information. If the matched routing information is found, the first core network device designates a server corresponding to an egress interface and a next-hop IP address included in the routing information as the target server. As another example, the routing information may also be represented in other manners, which are not limited herein. Correspondingly, in a case where the first core network device receives the uplink data information, the first core network device extracts the identity of the routing information from the uplink data information, and performs a routing query in the pre-saved routing table of the first core network device itself according to the identity of the routing information, to look for routing information (or a routing entry) that matches the identity of the routing information. If the matched routing information is found, the first core network device designates the server corresponding to the egress interface and a next-hop destination address (which may be a destination IP address or a destination layer 2 address, which is not limited herein) included in the routing information as the target server.

Optionally, in a case where the first information in the uplink data information includes the identity of the target server, the first core network device determines the target server based on the identity of the target server. Herein, in a case where the first core network device receives the uplink data information, the first core network device extracts the identity of the target server from the uplink data information, determines a target address according to the identity of the target server, and performs a routing query in the pre-saved routing table of the first core network device itself based on the target address to look for routing information that matches the routing-related identity. If the matched routing information is found, the first core network device designates a server corresponding to an egress interface and a next-hop address included in the routing information as the target server.

Optionally, in a case where the first information in the uplink data information includes the routing path information, the first core network device determines the target server based on the routing path information. Herein, the routing path information may include the addresses of one or more devices between the terminal device (not including the terminal device) and the target server (including the target server). The address of any one of device may be any one of an IP address, a layer 2 address, etc., which are not exhaustively listed herein. In some embodiments, when the first core network device receives the uplink data information, the first core network device extracts the routing path information from the uplink data information, and determines a server corresponding to a next-hop address as the target server according to the routing path information.

Optionally, determining, by the first core network device, the target server based on the first information in the uplink data information may include: determining, by the first core network device, the target server based on the first information in the uplink data information and second pre-configuration information.

In some embodiments, in a case where the first information in the uplink data information includes at least one of the device manufacturer identity, the service provider identity, or the identity of the terminal device, the first core network device selects the target server from one or more candidate servers based on the first information and the second pre-configuration information.

Herein, the second pre-configuration information is shared by one or more candidate core network devices, and the one or more candidate core network devices include the first core network device.

The second pre-configuration information includes: a parameter of a candidate device corresponding to each candidate server of one or more candidate servers; where the parameter of the candidate device includes at least one of: an identity of the candidate device, a service area of the candidate device, an identity of a candidate device manufacturer, or an identity of a candidate service provider.

The service area of the candidate device may be represented by one or more cell identities, may be represented by one or more tracking area identities, or may be identified by latitude and longitude information.

The second pre-configuration information may be information included in a shared database. The shared database may refer to a database shared by one or more candidate core network devices on the network side. As illustrated in the aforementioned embodiments, the candidate core network device may refer to a candidate AMF entity; i.e., the second pre-configuration information in the shared database may be used jointly by various candidate AMF entities. The shared database may be arranged in any one of network elements of the core network, or may be arranged in a separate server. For example, the shared database may be arranged in the AMF of the core network, in the UDM (Unified Data Management), or in any other network element, which is not exhaustively listed herein. For example, if the shared database is arranged in the separate server, the server may at least have communication interfaces with various core network elements, to cause the various core network elements read the contents of the shared database.

Herein, among the one or more candidate servers, different candidate servers may correspond to different candidate devices. The candidate device corresponding to any one of candidate server refers to one or more zero-power consumption devices managed or provided with services by any one of candidate servers. That is, the pre-configuration information may include a parameter of one or more zero-power consumption devices respectively corresponding to various candidate servers of all candidate servers. The aforementioned terminal device may be any one of zero-power consumption devices of all zero-power consumption devices corresponding to all candidate servers in the pre-configuration information.

It should be pointed out that, among the aforementioned one or more candidate core network devices, any one of candidate core network devices may pre-acquire and save the parameter of the candidate device reported by the one or more candidate servers, and different candidate core network devices may acquire parameters of one or more candidate devices reported by different candidate servers. For example, candidate core network device 1 acquires parameters of the candidate devices reported by candidate server 1 and candidate server 2, and saves the parameters of the candidate devices corresponding to candidate server 1 and candidate server 2,respectively in the pre-configuration information, to make that all candidate core network devices can share. Similarly, the candidate core network device 2 acquires the parameters of the candidate devices reported by candidate server 3 and candidate server 4, and saves the parameters of the candidate devices corresponding to candidate server 3 and candidate server 4 respectively in the pre-configuration information, to make that all candidate core network devices also can share.

Taking the first information including the identity of the terminal device as an example, the first core network device acquires an identity of a device included in the parameters of device corresponding to the one or more candidate servers from the second pre-configuration information, and acquires the identity of the terminal device from the first information in the uplink data information; the candidate server where an identity of device matching the identity of the terminal device is located is used as the target server. For example, the pre-configuration information includes three candidate servers, such as candidate server(s) 1 and candidate server(s) 2, respectively. The pre-configuration information further includes a parameter of device corresponding to each candidate server, for example, the parameter of device of device al corresponding to the candidate server 1 includes an identity of the device a1, and a parameter of device of device a2 corresponding to the candidate server 1 includes an identity of device a2; a parameter of device of device b1 corresponding to the candidate server 2 includes an identity of device b1, and a parameter of the device of device b2 corresponding to the candidate server 2 includes an identity of device b2; if the identity of the terminal device included in the uplink data information is the identity of device a2, it can be determined that the aforementioned candidate server 1 is selected as the target server this time.

Taking the first information including the device manufacturer identity as an example, the first core network device acquires an identity of a candidate device manufacturer in the parameters of device corresponding to the one or more candidate servers from the second pre-configuration information, and acquires one or more bits in the identity of the terminal device from the uplink data information; and designates the candidate server where the identity of the candidate device manufacturer that matches the one or more bits in the identity of the terminal device is located as the target server. In this case, the one or more bits in the identity of the terminal device may be one or more bits with a specified number and at a specified location, for example, first 8 bits in the identity of the terminal device are used to represent the device manufacturer identity and/or the service provider identity. Correspondingly, based on the specific contents of the one or more bits, a matching operation is performed with the identity of the candidate device manufacturer included in the current second pre-configuration information, and the candidate server where the matched identity of the candidate device manufacturer is located is designated as the target server.

After completing the aforementioned processing, the first core network device may perform the aforementioned S430, and the first core network device sends the uplink data information to the target server.

Optionally, sending, by the first core network device, the uplink data information to the target server, may be: directly sending, by the first core network device (i.e., the first AMF entity), the uplink data information to the target server.

Optionally, sending, by the first core network device, the uplink data information to the target server, may be: sending, by the first core network device, the uplink data information to the target server through a second core network device. Herein, the second core network device may be a NEF (Network Exposure Function) entity. This manner is mainly applicable to a case where the target server does not belong to the operator, that is, the target server is a server provided by a third party. In order to ensure the data security, the first core network device, i.e., the first AMF, is controlled to send the uplink data information to the target server through the NEF.

It should be pointed out that the aforementioned target server may be a target service server (SP). The target server refers to a server corresponding to the terminal device, or may refer to an SP that provides service support or service processing for the terminal device. The aforementioned candidate server may be a candidate service SP.

After completing the above processing, one procedure of sending the uplink data information of the terminal device, through the access network device, or the first core network device (or the first core network device and the second core network device), to the target server is completed.

In a implementation, in a case where there is downlink data that needs to be sent to the terminal device in the target server, the following processing may also be performed:
receiving, by the first core network device, the downlink data information sent from the target server; where the downlink data information is response information for the uplink data information; and
sending, by the first core network device, the downlink data information.

The aforementioned downlink data information sent by the target server to the first core network may be designated as confirmation information (or confirmation portion) for the uplink data information. That is, the target server does not actively send downlink data to the terminal device. Only the target server receives the uplink data information sent from the terminal device, and in a case where the target server needs to send the downlink data information, the downlink data information may be sent as the confirmation information for the uplink data information.

Herein, the downlink data information includes related information of the terminal device. The related information of the terminal device may be used to uniquely identify the terminal device. For example, the related information of the terminal device may include: an identity of the terminal device. As another example, the related information of the terminal device may include user information of the terminal device, and the user information may be an identity of a user, etc., which are not exhaustively listed herein.

The downlink data information is a downlink (DL) data container. Herein, the related information of the terminal device may be carried in a data portion of the downlink data information. In addition, the downlink data information may include service-related information that needs to be transmitted by the target server needs to the terminal device, which is not limited in the present embodiment.

Receiving, by the first core network device, the downlink data information sent from the target server may be: directly receiving, by the first core network device, the downlink data information sent from the target server. Alternatively, the above operation may further be: receiving, by the first core network device, the downlink data information sent from the target server through a second core network device. Similarly, the second core network device may be a NEF entity.

In one implementation, sending, by the first core network device, the downlink data information includes: sending, by the first core network device, the downlink data information to the access network device.

The first core network device may determine the access network device according to the related information of the terminal device, and send the downlink data information to the terminal device through the access network device.

Correspondingly, an operation of the access network device may include: receiving, by the access network device, the downlink data information sent from the first core network device; and sending, by the access network device, the downlink data information to the terminal device. Correspondingly, the terminal device receives the downlink data information sent from the access network device.

Here, the access network device may simultaneously manage or connect with one or more terminal devices. Therefore, after the access network device receives the downlink data information, the access network device may parse the downlink data information, determine which terminal device that the downlink data information is to be sent to based on the related information of the terminal device in the downlink data information, and then send the downlink data information to a corresponding terminal device.

In an implementation, sending, by the first core network device, the downlink data information includes: sending, by the first core network device, the downlink data information to the terminal device.

In a case where the first core network device sends the downlink data information to the terminal device, the downlink data information may be carried by a downlink NAS transport message. That is, the first core network device sends the downlink data information carried by the downlink NAS transport message to the terminal device. Correspondingly, the terminal device receives the downlink data information sent from the first core network device.

Furthermore, the first core network device may have a plurality of registered terminal devices. Since the downlink data information sent from the target server to the first core network carries the related information of the terminal device, the corresponding NAS connection may be determined based on the related information of the terminal device, and then the downlink data information carried by the downlink NAS transport message may be sent to the terminal device through the NAS connection.

In conjunction with FIG. 6, the methods provided in the aforementioned embodiments are exemplarily described by taking the aforementioned terminal device being a device as an example:
S601, providing, by a target server, a parameter of a candidate device to a core network device.

The core network device may be any one of one or more candidate core network devices, and the candidate core network device may be a candidate AMF. The operation may be: sending, by the target server, a parameter of a device managed by the target server itself to any one of one or more candidate AMFs, and the candidate AMF that receives the parameter of the device sent from the target server updates pre-configuration information. The pre-configuration information may be saved in a shared database so that one or more AMFs share the pre-configuration information.

It should be pointed out that the above description is only illustrated by the target server performing S601, in the actual processing, there may be one or more candidate servers, correspondingly, the aforementioned pre-configuration information may include a parameter of a candidate device corresponding to each candidate server of the one or more candidate servers; where the parameter of the candidate device corresponding to each candidate server is configured by each candidate server for one candidate core network device of the one or more candidate core network devices; the parameter of the candidate device is the same as that describe in the above embodiments, which is not be repeated herein.
S602, saving, by the core network device, a parameter of a device in pre-configuration information, and sharing, by the core network device, the pre-configuration information between different core network devices.
S603, pre-configuring, by the device, at least one of following information: routing-related information, a device manufacturer identity, a service provider identity, or an identity of a terminal device.

The descriptions of the routing-related information, the device manufacturer identity, the service provider identity, and the identity of the terminal device are the same as those described in the aforementioned embodiments, which are not be repeated herein.

The processing of S603 is the same as that described in the aforementioned embodiments, which is not be repeated herein. In addition, a performing occasion of S603 and performing occasions of the aforementioned S601 to S602 may in no order of precedence, that is, S601, S602, and S603 may be performed simultaneously; or S601 to S602 may be performed first, and then S603 may be performed; or S603 may be performed first and then S601 to S602 may be performed.

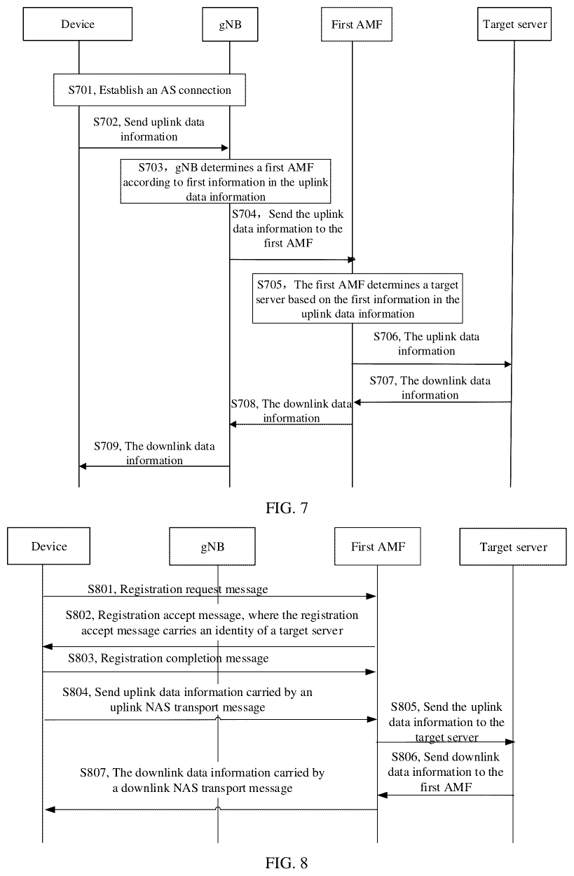

After completing the aforementioned processing, the device may send uplink data information to a gNB when the device needs to send service data. In some embodiments, in conjunction with FIG. 7, taking the terminal device being a device, and the first core network device being a first AMF as an example for description:
S701, in a case where a device is located in a target area, establishing, by the device, an AS connection with a gNB.
S702, sending, by the device, uplink data information to the gNB.

In some embodiments, the device sends the uplink data information to the gNB through the AS connection established with the gNB. Herein, the uplink data information may be an uplink data container, and the uplink data container may be a UL AIoT data container. In a header portion of the UL AIoT data container, at least one of first information may be included: a routing-related identity, a device manufacturer identity, and a service provider identity. The description of the first information is the same as that described in the aforementioned embodiments, which is not be repeated herein.
S703, determining, by the gNB, a first AMF according to first information in the uplink data information.

In some embodiments, in a case where the gNB enables that at least one of the routing-related identity, the device manufacturer identity, or the service provider identity in the first information is carried in the header portion of the uplink data container, the first AMF may be selected according to at least one of the routing-related identity, the device manufacturer identity, or the service provider identity in the first information.

In a case where the gNB does not enable that at least one of the routing-related identity, device manufacturer identity, or the service provider identity in the first information is carried in the header portion of the uplink data container, an AMF is arbitrarily selected as the first AMF. In addition, similar to the description of the aforementioned embodiments, in a case where the gNB does not enable that at least one of the routing-related identity, the device manufacturer identity, or the service provider identity in the first information is carried in the header portion of the uplink data container, an AMF may be selected as the first AMF according to the identity of the device carried in the data portion. The processing is the same as that described in the aforementioned embodiments, which is not be repeated herein.
S704, sending, by the gNB, the uplink data information to the first AMF.

In some embodiments, the gNB sends the UL AIoT data container to the first AMF.
S705, determining, by the first AMF, a target server based on the first information in the uplink data information.

The manner in which the first AMF determines the target server has been described in detail in the aforementioned embodiments, which is not be repeated herein.
S706, sending, by the first AMF, the uplink data information to the target server.

Here, although not illustrated in the figures, in one case, the first AMF may send the uplink data information to the target server through a NEF.
S707, sending, by the target server, downlink data information to the first AMF.

In some embodiments, the downlink data information is response information for the uplink data information; and the downlink data information may include an identity of a device. The downlink data information may be encapsulated as a DL data container. That is, in a case where there is DL data needs to be sent to the device in the target server, the target server may send the DL data container to the first AMF.

Here, although not illustrated in the figures, in one case, a target SP may send the downlink data information to the first AMF through the NEF.
S708, sending, by the first AMF, the downlink data information to the gNB.
S709, sending, by gNB, the downlink data information to the device.

Taking the terminal device being a device, the access network device being a gNB, and the first core network device being a first AMF as an example, and in conjunction with FIG. 8, a communication method provided in the present embodiment is exemplarily illustrated as follows, the communication method including:
S801, sending, by the device, a registration request message to the first AMF through the gNB.

That is, in a procedure of establishing a NAS connection between the device and the first AMF, S801 is performed first. S801 may include: establishing an RRC connection between the device and the gNB, and enabling a NAS message being carried in the RRC message. The NAS message here refers to a registration request message. The NAS message includes the ID of a device, a registration type, etc
S802, receiving, by the device, a registration accept message sent from the first AMF through the gNB, where the registration accept message carries an identity of a target server.

In some embodiments, after the first AMF acquires user data of the device, the first AMF returns a registration accept message to the device. The message may be used to carry 5G-GUTI and the identity of the target server. The identity of the target server may be represented as AIoT server ID; the AIoT server ID is used to indicate the destination identity (i.e., the identity of the target server) for the device to send AIoT data.

It should be understood that in S802, the registration accept message may not carry the identity of the target server. The identity of the target server may be pre-configured in the terminal device (i.e., the device).
S803, returning, by the device, a registration completion message to the first AMF through the NAS connection.
S804, sending, by the device, uplink data information carried by an uplink NAS transport message to the first AMF.

That is, in a case where the device is in a connected state, a UL NAS TRANSPORT (uplink NAS transport message) message is sent on the NAS connection, and the message includes uplink data information (which may be AIoT data); and the uplink data information may further include the identity of the target server. The identity of the target server may be contents contained in the routing information in the uplink data information. Similar to the aforementioned examples, the uplink data information may be an uplink data container, and the uplink data container may be a UL AIoT data container. The identity of the target server in the first information may be included in a header portion of the UL AIoT data container. The description of the first information is the same as that described in the aforementioned embodiments, which is not be repeated herein.
S805, sending, by the first AMF, the uplink data information to the target server.

In some embodiments, the first AMF sends the uplink data information to an appropriate server according to the identity of the target server (which may be represented as an AIoT server ID) included in the first information in the uplink data information carried in the uplink NAS transport message.

The operations for sending downlink data are as follows:
S806, sending, by the target server, downlink data information to the first AMF.

The downlink data information is a DL data container carried in a DL Transport message, and the downlink data information also needs to carry the identity of the device.
S807, sending, by the first AMF, the downlink data information carried by a downlink NAS transport message to the device.

That is, the first AMF enables that the downlink data information is carried in a DL NAS TRANSPORT message (downlink NAS transport message) and sends the downlink NAS transport message to the device, where the message carries the downlink data information (which may be an AIoT data container).

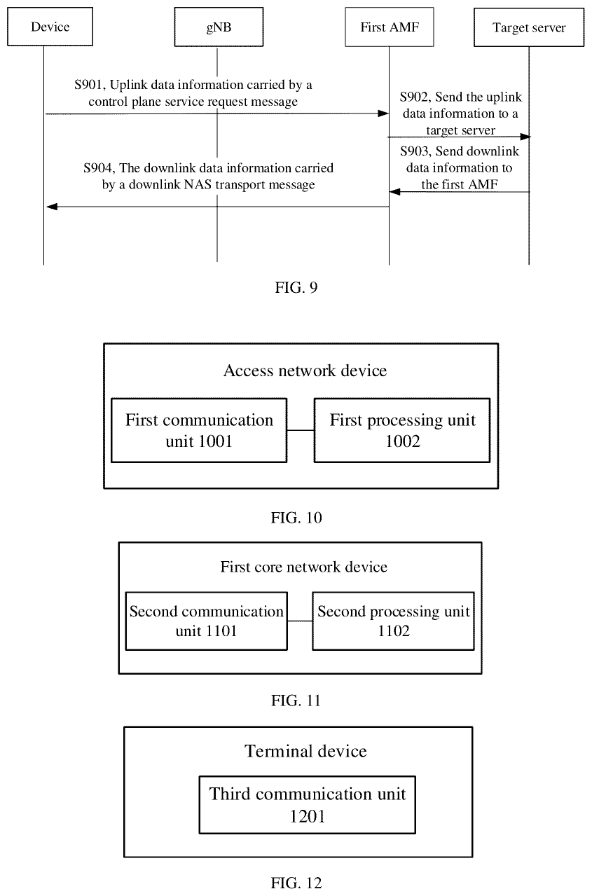

Taking the terminal device being a device, the access network device being a gNB, and the first core network device being a first AMF as an example, and in conjunction with FIG. 9, a communication method provided in the present embodiment is exemplarily illustrated as follows, the communication method including:
S901, sending, by the device, uplink data information carried by a control plane service request message to the first AMF.

Differ from the aforementioned exemplary description, in this operation, the registration procedure of S801 to S803 may have been completed before S901 is performed. However, the device is currently in an idle state (or non-connected state), if there is AIoT data (i.e., the uplink data information) that needs to be sent in the device, the device may directly send the control plane service request message (this message may cause the device enter a connected state) to the first AMF. The control plane service request message includes the AIoT data (i.e., the uplink data information); and the uplink data information may also include an identity of a target server, which is the same as the aforementioned exemplary description, and is not be repeated herein.
S902, sending, by the first AMF, the uplink data information to a target server.

In some embodiments, the first AMF sends the uplink data information to an appropriate server according to the identity of the target server (which may be represented as an AIoT server ID) included in the uplink data information carried in the uplink NAS transport message.

The operations for sending the downlink data are as follows:
S903, sending, by the target server, downlink data information to the first AMF.
S904, sending, by the first AMF, the downlink data information carried by a downlink NAS transport message to the device.

Here, the processing of S903 and S904 is the same as the processing of S806 and S807 described in the aforementioned examples, which may not be repeated herein.

It could be seen that by adopting the above-mentioned solutions, the device on the network side may determine the target server for data transmission this time according to the uplink data information sent from the terminal device, and directly send the uplink data information to the target server. In this way, the complex communication processes that required to be performed by the terminal device only for transmitting data to the network side can be simplified, and the signaling overhead caused by the complex communication processes can be reduced; especially in a scenario with the application of a zero-power consumption terminal, the low-complexity feature of the zero-power consumption terminal can be more adaptable.

FIG. 10 is a schematic block diagram of an access network device according to an embodiment of the present application. The access network device may include:
a first communication unit 1001, configured to receive uplink data information sent from a terminal device; and send the uplink data information to a first core network device;
a first processing unit 1002, configured to determine the first core network device based on first information in the uplink data information.

The first information includes: routing-related information.

The routing-related information includes at least one of: routing-related identification or routing path information.

The routing-related identity includes at least one of: an identity of routing information or an identity of a target server.

The first information includes at least one of: a device manufacturer identity, a service provider identity, or an identity of the terminal device.

The uplink data information includes an uplink data container.

The first information is carried by a header portion of the uplink data container, or the first information is carried by a data portion of the uplink data container.

The first processing unit 1002 is configured to determine the first core network device based on the routing-related information of the first information in the uplink data information.

The first processing unit 1002 is configured to determine the first core network device based on first information in the uplink data information and first pre-configuration information.

The first pre-configuration information includes: a parameter of a candidate device corresponding to a candidate server and supported by each candidate core network device of one or more candidate core network devices; where the parameter of the candidate device corresponding to the candidate server includes at least one of: an identity of a candidate device manufacturer, an identity of a candidate service provider, or an identity of a candidate device.

The first communication unit 1001 is configured to receive the uplink data information sent from the terminal device through an access stratum (AS) connection between the access network device and the terminal device.

The first communication unit 1001 is configured to receive downlink data information sent from the first core network device; where the downlink data information is response information for the uplink data information; and send the downlink data information to the terminal device.

The downlink data information includes related information of the terminal device.

The downlink data information includes a downlink data container.

The terminal device is a zero-power consumption device, and/or the first core network device is a first access and mobility management function (AMF) entity.

FIG. 11 is a schematic block diagram of a first core network device according to an embodiment of the present application. The device may include:
a second communication unit 1101, configured to receive uplink data information; and send the uplink data information to a target server;
a second processing unit 1102, configured to determine the target server based on first information in the uplink data information.

The first information includes: routing-related information.

The routing-related information includes at least one of: routing-related identification or routing path information.

The routing-related identity includes at least one of: an identity of routing information or an identity of a target server.

The first information includes at least one of: a device manufacturer identity, a service provider identity, or an identity of a terminal device.

The uplink data information is an uplink data container.

The first information is carried by a header portion of the uplink data container, or the first information is carried by a data portion of the uplink data container.

The second processing unit is configured to determine the target server based on the routing-related information in the first information in the uplink data information.

The second processing unit is configured to determine the target server based on the first information in the uplink data information and second pre-configuration information.

The second pre-configuration information is shared by one or more candidate core network devices, and the one or more candidate core network devices include the first core network device;
the second pre-configuration information includes: a parameter of a candidate device corresponding to each candidate server of one or more candidate servers; where the parameter of the candidate device comprises at least one of: an identity of the candidate device, a service area of the candidate device, an identity of a candidate device manufacturer, or an identity of a candidate service provider.

The second communication unit is configured to receive the uplink data information sent from the access network device.

The second communication unit is configured to receive the uplink data information sent from the terminal device.

The second communication unit is configured to receive the uplink data information carried by an uplink NAS transport message and sent from a terminal device; or to receive the uplink data information carried by a control plane service request message and sent from a terminal device.

The second communication unit is configured to establish a non-access stratum (NAS) connection with the terminal device.

The second communication unit is configured to receive a registration request message sent from the terminal device through an access network device; send a registration accept message to the terminal device through the access network device, where the registration accept message is used to indicate that an establishment of the NAS connection between the terminal device and the first core network device has been completed; and receive a registration completion message sent from the terminal device through the NAS connection.

The registration accept message carries the identity of the target server.

The second communication unit is configured to send the uplink data information to the target server through a second core network device.

The second communication unit is configured to receive downlink data information sent from the target server, where the downlink data information is response information for the uplink data information; and send the downlink data information.

The downlink data information includes related information of the terminal device.

The downlink data information is a downlink data container.

The second communication unit is configured to receive the downlink data information sent from the target server through the second core network device.

The second core network device is a network exposure function (NEF) entity.

The second communication unit is configured to send the downlink data information to the access network device.

The second communication unit is configured to send the downlink data information to the terminal device.

The second communication unit is configured to send the downlink data information carried by a downlink NAS transport message to the terminal device.

The terminal device is a zero-power consumption device, and/or the first core network device is a first AMF entity.

FIG. 12 is a schematic block diagram of a terminal device according to an embodiment of the present application. The terminal device may include:
a third communication unit 1201, configured to send uplink data information; where first information in the uplink data information is used to determine a first core network device and/or a target server.

The first information includes: routing-related information.

The routing-related information includes at least one of: a routing-related identity, or routing path information.

The first information includes at least one of: a device manufacturer identity, a service provider identity, or an identity of the terminal device.

The routing-related information is pre-configured; and/or at least one of the device manufacturer identity, the service provider identity, or the identity of the terminal device is pre-configured.

The uplink data information includes an uplink data container.

The first information is carried by a header portion of the uplink data container, or the first information is carried by a data portion of the uplink data container.

The third communication unit is configured to send the uplink data information to an access network device through an access stratum (AS) connection between the terminal device and the access network device.

The third communication unit is configured to establish the AS connection with the access network device in a case where the terminal device is located in a target area, where the target area is pre-configured.

The third communication unit is configured to send uplink data information to the first core network device.

The uplink data information is carried by an uplink NAS transport message, or carried by a control plane service request message.

The third communication unit is configured to establish a non-access stratum (NAS) connection with the first core network device.

The third communication unit is configured to send a registration request message to the first core network device through the access network device; receive a registration accept message sent from the first core network device through the access network device, where the registration accept message is used to indicate that an establishment of the NAS connection between the terminal device and the first core network device has been completed; and return a registration completion message to the first core network device through the NAS connection.

The registration accept message carries the identity of the target server.

The third communication unit is configured to receive downlink data information, where the downlink data information is response information for the uplink data information.

The third communication unit is configured to receive the downlink data information sent from the access network device.

The third communication unit is used to receive the downlink data information sent from the first core network device.

The downlink data information is carried by a downlink NAS transport message.

The downlink data information includes related information of the terminal device.

The downlink data information includes a downlink data container.

The terminal device is a zero-power consumption device, and/or the first core network device is a first AMF entity.

It should be understood that, in addition to the third communication unit mentioned above, the terminal device may further include a third processing unit, the third processing unit can perform processing such as generating the uplink data information in the aforementioned communication methods, which may not be repeated herein.

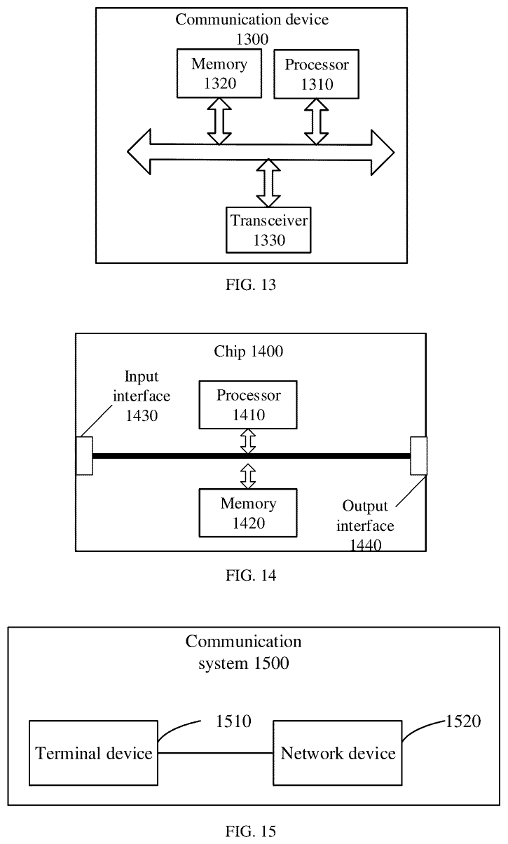

FIG. 13 is a schematic structural diagram of a communication device 1300 according to the embodiments of the present application. The communication device 1300 includes a processor 1310, the processor 1310 may invoke and execute a computer program from a memory to cause the communication device 1300 to implement the method in the embodiments of the present application.

In a possible implementation, the communication device 1300 may further include a memory 1320. Herein, the processor 1310 may invoke and execute a computer program from the memory 1320 to cause the communication device 1300 to implement the method in the embodiments of the present application.

Herein, the memory 1320 may be a separate device independent from the processor 1310, or may also be integrated into the processor 1310.

In one possible implementation, the communication device 1300 may also include a transceiver 1330, and the processor 1310 may control the transceiver 1330 to communicate with other devices, and for example, to send information or data to other devices, or receive information or data sent from other devices.

Herein, the transceiver 1330 may include a transmitter and a receiver. The transceiver 1330 may further include an antenna, and the number of antenna may be one or more.

In one possible implementation, the communication device 1300 may be an access network device of the embodiments of the present application, and the communication device 1300 may implement the corresponding processes implemented by the access network device in various methods in the embodiments of the present application, which may not be described here for the sake of brevity.

In one possible implementation, the communication device 1300 may be a first core network device in the embodiments of the present application, and the communication device 1300 may implement the corresponding processes implemented by the first core network device in various methods in the embodiments of the present application, which may not be described here for the sake of brevity.

In one possible implementation, the communication device 1300 may be the terminal device in the embodiments of the present application, and the communication device 1300 may implement the corresponding processes implemented by the terminal device in various methods in the embodiments of the present application, which may not be described here for the sake of brevity.

FIG. 14 is a schematic structural diagram of a chip 1400 according to the embodiments of the present application. The chip 1400 includes a processor 1410, the processor 1410 may invoke and execute a computer program from a memory to implement the methods in the embodiments of the present application.

In a possible implementation, the chip 1400 may further include a memory 1420. Herein, the processor 1410 may invoke and execute a computer program from the memory 1420 to implement the methods performed by the terminal device or the access network device in the embodiments of the present application.

Herein, the memory 1420 may be a separate device independent from the processor 1410, or may also be integrated into the processor 1410.

In one possible implementation, the chip 1400 may further include an input interface 1430. Herein, the processor 1410 may control the input interface 1430 to communicate with other devices or chips, and for example, the input interface 730 may acquire information or data sent from other devices or chips.

In one possible implementation, the chip 1400 may further include an output interface 1440. Herein, the processor 1410 may control the output interface 1440 to communicate with other devices or chips, and for example, the output interface 740 may output information or data to other devices or chips.

In one possible implementation, the chip can be applied to the access network device in the embodiments of the present application, and the chip can implement the corresponding processes implemented by the access network device in various methods in the embodiments of the present application.

In one possible implementation, the chip can be applied to the first core network device in the embodiments of the present application, and the chip can implement the corresponding processes implemented by the first core network device in various methods in the embodiments of the present application.

In one possible implementation, the chip can be applied to the terminal device in the embodiments of the present application, and the chip can implement the corresponding processes implemented by the terminal device in various methods in the embodiments of the present application.

The chips used in the access network device and the terminal device may be a same chip or different chips.

It should be understood that the chip mentioned in the embodiments of the present application may also be referred to as a system-level chip, a system chip, a chip system or a system-on-chip chip, etc.

The above-mentioned processor may be a general-purpose processor, a digital signal processor (digital signal processor, DSP), a field programmable gate array (field programmable gate array, FPGA), an application specific integrated circuit (application specific integrated circuit, ASIC) or other programmable logic devices, a transistor logic device, a discrete hardware component, etc. Herein, the above-mentioned general purpose processor may be a microprocessor or any conventional processor, etc.

The above-mentioned memory may be a volatile memory or a non-volatile memory, or may include both volatile and non-volatile memories. Herein, the non-volatile memory may be a Read-Only Memory (read-only memory, ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (random access memory, RAM).

It should be understood that the above memory is exemplary but not limiting illustration, e.g., the memory in embodiments of the present application may also be a static Random Access Memory (static RAM, SRAM), a Dynamic Random Access Memory (dynamic RAM, DRAM), a synchronous DRAM (synchronous DRAM, SDRAM), a double data rate SDRAM (double data rate SDRAM, DDR SDRAM), an enhanced SDRAM (enhanced SDRAM, ESDRAM), a synch link DRAM (synch link DRAM, SLDRAM), and a Direct Rambus RAM (Direct Rambus RAM, DR RAM), etc. That is, the memory in the embodiments of the present application is intended to include, but not limited to, these and any other suitable types of memories.

FIG. 15 is a schematic block diagram of a communication system 1500 according to the embodiments of the present application. The communication system 1500 includes a terminal device 1510 and a network device 1520.

Herein, the terminal device 1510 may be used to implement the corresponding functions implemented by the terminal device in the above methods, and the network device 1520 may be used to implement the corresponding functions implemented by the network device (the access network device and/or the first core network device) in the above methods, which may not be repeated herein for the sake of brevity.

The above embodiments may be implemented in whole or in part by software, hardware, firmware, or any combination thereof. When the above embodiments are implemented by using software, they may be implemented in the form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a non-transitory computer-readable storage medium or transmitted from one non-transitory computer-readable storage medium to another non-transitory computer-readable storage medium, for example, the computer instructions may be transmitted from a website site, computer, server, or data center to another website site, computer, server, or data center via wired (e.g., a coaxial cable, an optical fiber, a digital subscriber line (Digital Subscriber Line, DSL)) or wireless (e.g., infrared, wireless, microwave, etc.) manners. The non-transitory computer-readable storage medium may be any available medium that may be accessed by a computer or a data storage device such as including a server or a data center that contains one or more available media. The available medium may be a magnetic medium (e.g., a floppy disk, a hard disk, a magnetic tape), an optical medium (e.g., a DVD), or a semiconductor medium (e.g., a solid state disk (Solid State Disk, SSD)).

It should be understood that in the various embodiments of the present application, a size of the serial numbers of the above-mentioned various processes does not mean the order of performing. The performing order of various procedures should be determined by its function and internal logic, and should not constitute any limitation to the implementation process of the embodiments of the present application.

It may be clearly understood by those skilled in the art that, for convenience and brevity of the description, the working procedures of the system, the apparatus and the unit described above may refer to the corresponding procedures in the above method embodiments, which will not be repeated here.

The above contents are only exemplary implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. An access network device, comprising: a processor and a memory, wherein the memory is configured to store a computer program, the processor is configured to invoke and execute the computer program stored in the memory, to cause the access network device to perform:
receiving uplink data information sent from a terminal device;
determining a first core network device based on first information in the uplink data information; and
sending the uplink data information to the first core network device.

2. The access network device according to claim 1, wherein the first information comprises:
routing-related information;
wherein the routing-related information comprises at least one of: a routing-related identity or routing path information; or
the first information comprises at least one of: a device manufacturer identity, a service provider identity, or an identity of the terminal device.

3. The access network device according to claim 2, wherein the uplink data information comprises an uplink data container;
wherein the first information is carried by a header portion of the uplink data container, or the first information is carried by a data portion of the uplink data container.

4. The access network device according to claim 2, wherein the access network device performs:
determining the first core network device based on the routing-related information in the first information in the uplink data information; or
determining the first core network device based on the first information in the uplink data information and first pre-configuration information.

5. The access network device according to claim 4, wherein the first pre-configuration information comprises: a parameter of a candidate device corresponding to a candidate server and supported by each candidate core network device of one or more candidate core network devices; the parameter of the candidate device corresponding to the candidate server comprises at least one of: an identity of a candidate device manufacturer, an identity of a candidate service provider, or an identity of a candidate device.

6. The access network device according to claim 1, wherein the access network device performs:
receiving the uplink data information sent from the terminal device through an access stratum (AS) connection between the access network device and the terminal device.

7. The access network device according to claim 1, wherein the access network device further performs:
receiving downlink data information sent from the first core network device; wherein the downlink data information is response information for the uplink data information; and
sending the downlink data information to the terminal device.

8. A first core network device, comprising: a processor and a memory, wherein the memory is configured to store a computer program, the processor is configured to invoke and execute the computer program stored in the memory, to cause the first core network device to perform:
receiving uplink data information;
determining a target server based on first information in the uplink data information; and
sending the uplink data information to the target server.

9. The first core network device according to claim 8, wherein the first information comprises:
routing-related information;
wherein the routing-related information comprises at least one of: a routing-related identity or routing path information; or
the first information comprises at least one of: a device manufacturer identity, a service provider identity, or an identity of a terminal device.

10. The first core network device according to claim 9, wherein the uplink data information is an uplink data container;
wherein the first information is carried by a header portion of the uplink data container, or the first information is carried by a data portion of the uplink data container.

11. The first core network device according to claim 9, wherein the first core network device performs:
determining the target server based on the routing-related information in the first information in the uplink data information; or
determining the target server based on the first information in the uplink data information and second pre-configuration information.

12. The first core network device according to claim 11, wherein the second pre-configuration information is shared by one or more candidate core network devices, and the one or more candidate core network devices comprise the first core network device; and
the second pre-configuration information comprises: a parameter of a candidate device corresponding to each candidate server of one or more candidate servers; wherein the parameter of the candidate device comprises at least one of: an identity of the candidate device, a service area of the candidate device, an identity of a candidate device manufacturer, or an identity of a candidate service provider.

13. The first core network device according to claim 8, wherein the first core network device performs:
receiving the uplink data information sent from an access network device; or
receiving the uplink data information carried by an uplink NAS transport message and sent from the terminal device; or
receiving the uplink data information carried by a control plane service request message and sent from the terminal device.

14. The first core network device according to claim 13, wherein the first core network device further performs:
receiving a registration request message sent from the terminal device through an access network device;
sending a registration accept message to the terminal device through the access network device; wherein the registration accept message is used to indicate that an establishment of the NAS connection between the terminal device and the first core network device have been completed; and
receiving a registration completion message sent from the terminal device through the NAS connection.

15. A terminal device, comprising: a processor and a memory, wherein the memory is configured to store a computer program, the processor is configured to invoke and execute the computer program stored in the memory, to cause the terminal device to perform:
sending uplink data information; wherein first information in the uplink data information is used to determine a first core network device and/or a target server.

16. The terminal device according to claim 15, wherein the first information comprises:
routing-related information;
wherein the routing-related information comprises at least one of: a routing-related identity or routing path information; or
the first information comprises at least one of: a device manufacturer identity, a service provider identity, or an identity of the terminal device.

17. The terminal device according to claim 16, wherein the uplink data information comprises an uplink data container;
wherein the first information is carried by a header portion of the uplink data container, or the first information is carried by a data portion of the uplink data container.

18. The terminal device according to claim 16, wherein the terminal device performs:
sending the uplink data information to an access network device through an access stratum (AS) connection between the terminal device and the access network device; or
sending the uplink data information to the first core network device.

19. The terminal device according to claim 18, wherein the uplink data information is carried by an uplink NAS transport message or carried by a control plane service request message.

20. The terminal device according to claim 19, wherein the terminal device further performs:
sending a registration request message to the first core network device through an access network device;
receiving a registration accept message sent from the first core network device through the access network device; wherein the registration accept message is used to indicate that an establishment of the NAS connection between the terminal device and the first core network device have been completed; and
returning a registration completion message to the first core network device through the NAS connection.
